(19) United States
(12) Patent Application Publication
(10) Pub. No.: US 2009/0240955 A1
(43) Pub. Date: Sep. 24, 2009

(54) SECURE MEDIA STORAGE DEVICE AND METHOD OF SECURING MEDIA STORAGE DEVICES

(75) Inventors: Andrew Chow, Singapore (SG); T.S. Anthony Ho, Singapore (SG); Tien Peng Cyril Tan, Singapore (SG); Jun Shen, Singapore (SG); Wee Meng Jeremiah Woon, Singapore (SG)

Correspondence Address: SUGHRUE MION, PLLC, 2100 PENNSYLVANIA AVENUE, N.W., SUITE 800, WASHINGTON, DC, 20037, US

(73) Assignee: Datamark Technologies PTE Ltd., Singaore (SG)

(21) Appl. No.: 12/302,729

(22) PCT Filed: May 30, 2007
(86) PCT No.: PCT/SG2007/000152

§ 371 Date: Feb. 19, 2009

(30) Foreign Application Priority Data
May 31, 2006 (AU) 2006902957

(51) Int. Cl. G06F 12/14; H04L 9/28; G06F 21/00

(52) U.S. Cl. 713/193; 380/28; 726/26

(57) ABSTRACT

A secure media storage device for an imaging device, comprising an interface (40) for receiving digital data, a memory (44) for storing the digital data and for allowing read out of the digital data and a security layer (42) integrated onto the storage device for embedding security data onto the digital data to enable verification of the integrity of the digital data.

The present invention relates to a secure media storage device and a method of securing media on a storage device. The invention has particular application, but not exclusive application, to securing images provided by a digital still camera and a digital surveillance camera without significant change to the architecture of those devices.

### BACKGROUND OF THE INVENTION

The risk of forgery on digital media content such as images and video is exacerbated by the proliferation of advanced editing software. The digital media information that is residing on the storage media card, is not protected and basically openly at risk for illegal tampering after being captured by the imaging devices. For example, digital images can be easily tampered with if the storage card falls into the wrong hands. This means the rightful owner cannot claim that the photograph is the true original copy or that it is taken from his or her camera at a particular day and time.

In addition, emerging real-time video streaming for instant media access on the Internet also poses a big problem. The advantage of sending a lower volume of data per time unit across a network (bit-rate), using MPEG-4 standard is prone to theft and piracy of digital video media, resulting in difficulties in owner identification.

Cryptography has been widely known as a very popular scheme for protecting digital multimedia data. However, these traditional protection mechanisms, such as encryption, are no longer sufficient because when the digital content is decrypted, protection offered by encryption no longer exists. In recent years, from the viewpoint of protecting the copyright of digitized multimedia data such as image and video, the digital watermark technology has been investigated as a complementary technology.

Digital Watermarking evolved from a technology term known as digital steganography. The word ‘steganography’ actually stems from a Greek word meaning ‘covered writing’. In general, digital watermarking is a technique for embedding a predetermined information in multimedia data (e.g. image or video) in accordance with a predetermined rule so that the predetermined information cannot be extracted from the multimedia data without using at least the predetermined rule. With digital watermarking complemented with digital signature schemes (which we shall call security algorithms hereafter), the digitized multimedia data can be safeguarded at the very moment it is first created.

To solve this problem, there are a few ways that such security algorithms can be employed on existing imaging devices. A commonly used method is to integrate the security algorithms, in the form of a firmware, into an existing imaging device's firmware, which could reside on an intelligent programmable device such as ARM (Advanced RISC Machine) or a DSP (Digital Signal Processor) core. In the case of a digital camera, the security algorithms can be integrated into the firmware, just after an image has been processed by the hardware accelerator engines on the digital camera, such as CCD processing and AE/AF/AWB processing, and before it has been saved onto the storage card.

Another technique is to design the security algorithms in the form of a hardware ASIC (Application-Specific Integrated Circuit) chip and integrate it into existing imaging devices' hardware architecture. This chip would be operated just like any other hardware engines in the imaging device.

However, in many cases, it is not an easy task to employ the above-mentioned schemes into existing imaging devices such as digital still cameras and surveillance video cameras. Though the schemes are able to secure the digital media information, there are a few drawbacks:
1) Both methods require changes and may complicate the internal architecture design of the imaging devices, be it firmware or hardware.
2) The performance of the imaging devices might also be reduced at the expense of the security algorithms such as digital watermarking and/or cryptography schemes.
3) These types of integration would result in a limited choice of “authentication” devices for consumers, as they are typically very customized.

### SUMMARY OF THE INVENTION

The object of the invention is to provide a device and method which overcomes the above drawbacks.

The invention may be said to reside in a secure media storage device for an imaging device, comprising:
an interface for receiving digital data;
a memory for storing the digital data and for allowing read out of the digital data; and
a security layer integrated onto the storage device for embedding security data onto the digital data to enable verification of the integrity of the digital data.

In an embodiment, the interface is adapted to receive digital data captured by an imaging device whereby the digital data can be read out of the memory to provide an image and the integrity of the image can be verified.

Thus, the digital data can be secured and verification of the integrity data provided at the time of readout by the embedded security data. Thus, in the example of imaging devices, the invention provides the advantage that manufacturers not need make unnecessary complex changes to the architecture and design of their imaging devices, overall performance of the image device is not compromised, digital media content such as still images and video is immediately protected once captured by the imaging device, and consumers have a choice to secure their content, whilst still using the same imaging device. For example, a customer can still use a normal CF card with his/her digital camera if he/she does not need to secure the digital images stored on the card.

The interface for receiving digital data captured by the imaging device may be a standard memory card interfaces such as CF, SD, MMC or a SATA interface, which appears on 2.5 inch hard disk. The interface may also be a USB interface or any other possible interfaces to the imaging device, including a wireless interface.

Preferably the security layer comprises a device for implementing a security algorithm.

The security algorithm may be digital watermarking.

The security data may be comprised of one or more of an media device identification, a time stamp and a date stamp.

The security algorithm may also comprise a cryptographic algorithm.

The cryptography algorithm may comprise a digital signature algorithm. The security algorithm may also comprise a message digest algorithm.

Other forms of security algorithms may also be used.

In one embodiment of the invention the memory comprises a flash memory controlled by a memory controller. The memory need not be specifically flash but any forms of memory, for example, a magnetic storage medium such as a 2.5 inch hard disk or even a Solid State disk.

In one embodiment the device for implementing the security algorithm comprises a security controller.

The digital signature algorithm may comprise hashing part of the digital data to provide a fingerprint and employing private key encryption so that the entire signature forms part of a watermark bit stream watermarked onto the digital data. Thus, the watermark is decrypted by a public key so the decrypted hashed fingerprint is compared to the hash fingerprint of the digital data to determine whether the image is valid or has been tampered with and is therefore invalid.

The invention still further provides a digital media device having a secure media storage device as described above, for example a digital imaging device.

The invention may also be said to reside in a method of securing digital data, comprising:
receiving digital data onto a storage device;
storing the digital data on the storage device and allowing readout of the digital data; and
providing a security layer integrated onto the storage device to embed security data onto the digital data to enable verification of the integrity of the digital data.

Preferably the security layer comprises a security algorithm.

The security algorithm may be a digital watermarking algorithm.

The security data selected from the group consisting of media device identification and time and date stamp.

The security algorithm may also comprise a cryptographic algorithm.

The cryptographic algorithm may be a digital signature algorithm and/or a message digest algorithm.

Other forms of security algorithms may also be used.

In one embodiment of the invention the memory comprises a flash memory controlled by a memory controller. The memory need not be specifically flash but any forms of memory, which includes the memory that sits on a 2.5 inch hard disk or even latest Solid State disk.

In one specific embodiment, the security algorithm may further comprise a digital signature algorithm.

The digital signature algorithm may comprise hashing part of the digital data to provide a fingerprint and employs private key encryption so that the entire signature forms part of a watermark bit stream watermarked onto the digital data. Thus, the watermark is decrypted by a public key so the decrypted hashed fingerprint is compared to the hash fingerprint of the digital data to determine whether the image is valid or has been tampered with and is therefore invalid.

### BRIEF DESCRIPTION OF THE DRAWINGS

Preferred embodiments of the invention will be described, by way of example, with reference to the accompanying drawings in which:

FIG. 1 is a block diagram illustrating a prior art security technique;

FIG. 2 is a block diagram of an imaging device having a secure media storage device according to one embodiment of the invention;

FIG. 3 is a diagram illustrating workflow of the storage device of FIG. 2;

FIG. 4 is a block diagram illustrating how digital signatures are used in one embodiment of the invention;

FIG. 5 is a drawing showing how verification is provided to a user.

FIG. 6 is a block diagram of a USB token; and

FIG. 7 is a flow chart.

### DETAILED DESCRIPTION OF THE PREFERRED EMBODIMENTS

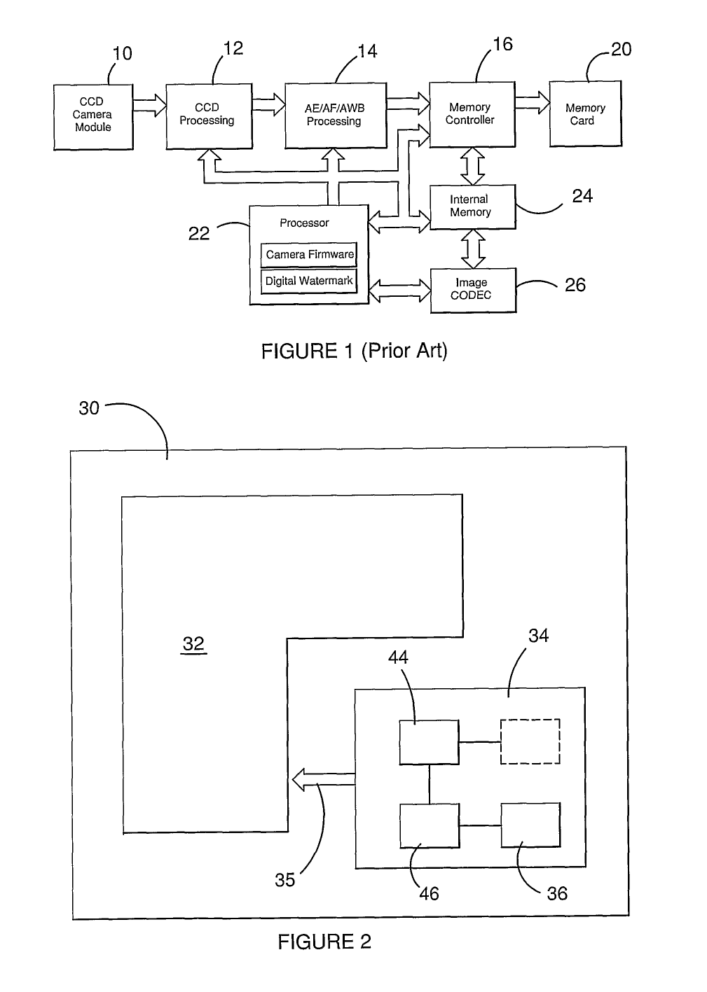

FIG. 1 illustrates a prior art security technique as described above which has a CCD module 10, a processing section 12 for processing data captured by the CCD module, AE/AF/AWB processing module 14, a memory controller 16 and a memory card 20. A processor 22 is provided for controlling the modules 12, 14 and 16 and also an internal memory 24 and an image codec 26. In this device, security algorithms in the form of firmware are integrated into the device firmware. The security algorithms can be integrated into the firmware just after an image has been processed by the hardware accelerator engines in the module 14 and before it has been saved on the memory card 20.

FIG. 2 shows an embodiment of the invention incorporated into an image device 30 which may be a digital camera, digital video camera, or the like. The device 30 includes a processing section 32 which contains the conventional processing circuitry for capturing and processing the image and a secure media device 34. The device may be a Compact Flash (CF) card, Secure Digital (SD) card, Multimedia (MMC) card, a hard disk or a Universal Serial Bus (USB) token and has all of the componentry for storing and reading out the digital data located on the card, together with a digital security processor 36 which forms a security controller for securing the digital image data stored on the card 34. The interface 35 may be any possible interfaces to the image device 30 and that includes standard memory interfaces such as CF, SD, MMC, USB or a wireless interface.

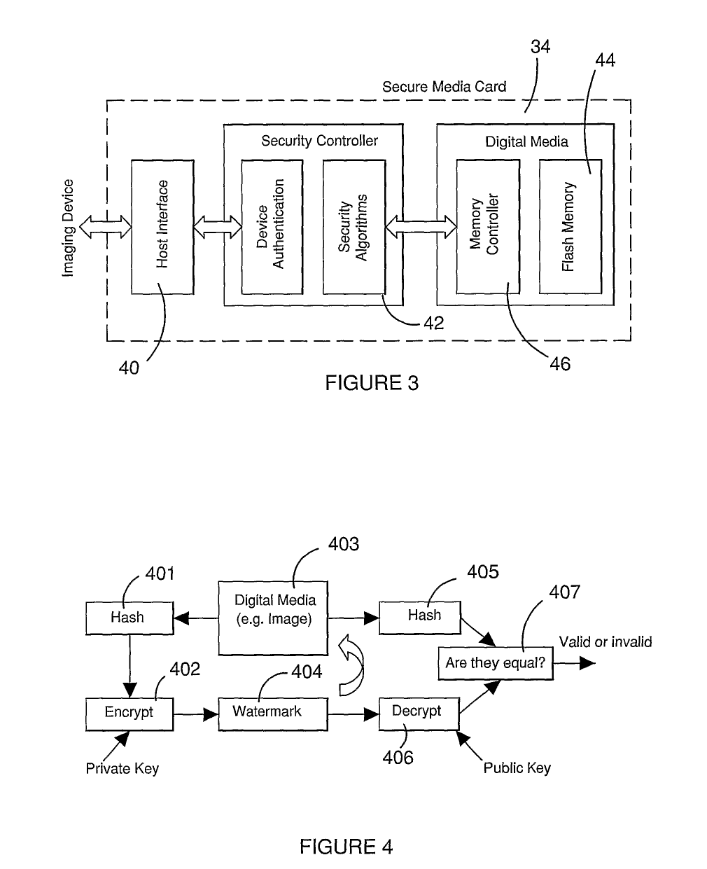

FIG. 3 shows an example workflow of the Secure Media Card 34. Digital data captured by the imaging device is provided by an interface 40 to the security controller 42 for storage in a flash memory 44 under the control of a memory controller 46. The security controller verifies the imaging device 30 as an authorised imaging device and will then secure the digital data using the onboard security algorithms within the security controller 42 and save the secured digital data in the flash memory 44.

FIG. 6 shows an example workflow of a Secure USB token 634. The security controller 642 verifies the imaging device 30 as an authorized imaging device. It then reads the digital data residing inside the imaging device and secures the digital data using the onboard security algorithms within the security controller 642. The memory controller 646 then saves the secured digital data in the flash memory 644.

The security algorithms used by the controller 42 may include robust digital watermarking which could include details such as the imaging devices ID, time and date stamp to provide ownership at a later date, cryptography schemes such as digital signatures (e.g. public key infrastructure) and message digest schemes employed as fragile watermarks to ensure the digital content is authentic, or any other form of security algorithm capable of securing the digital content on the card 34.

Robust watermarking is designed to withstand accidental and malicious attacks such as content alteration, compression, filtering and cropping. In addition, the use of fragile watermarking detects if there has been any change made on the digital content stored on the card 34.

To further secure the watermarking algorithm, digital signature algorithms could be incorporated. For example, if digital data which forms an image is to be protected, part of the data is first hashed to obtain a fingerprint, followed by private key encryption for authentication. The entire signature would form part of the watermark bit stream which would be watermarked onto the digital data stored onto the flash memory 44.

FIG. 4 is a block diagram showing how the digital signatures are employed to protect the digital data. Part of the data which is hashed at step 401 is encrypted at step 402 from the digital data represented at block 403. The encrypted data is watermarked at step 404. The same fingerprint is obtained at step 404 and the encrypted fingerprint at step 402 is decrypted at step 406 to determine if the hashed fingerprint at step 405 and the decrypted hashed fingerprint at step 406 are equal as per step 407. If so, the data is valid and has not been compromised. If not, the data is invalid and has been compromised.

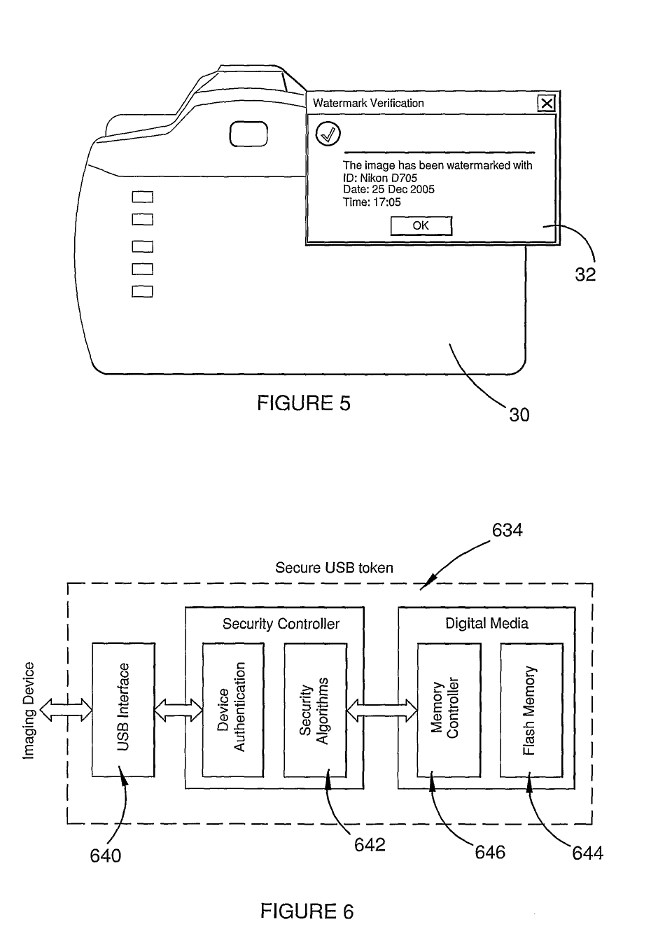

When an image is displayed which has been secured in accordance with the preferred embodiment of the invention, a window may open or box may be displayed which verifies that the image has not been tampered with, as shown in FIG. 5. For example, the display on a digital camera 30 may supply a watermark verification 32 which indicates that the image has been watermarked and provide the identification date and time and a message to indicate that the image has not been tampered.

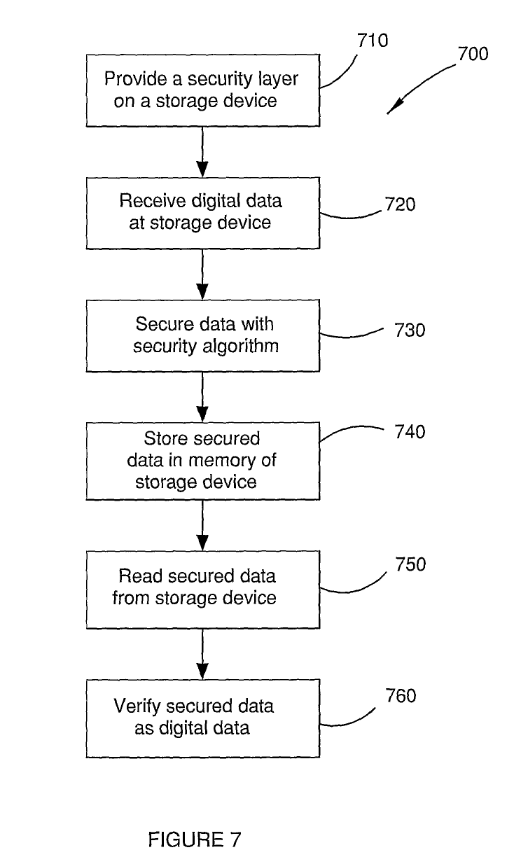

This method 700 is summarised in FIG. 7. A security layer is provided on a storage device 710. Digital data is received at the storage device 720. The digital data is secured with a security algorithm 730 and stored 740 in the member of the storage device. At some later point in time, the secured data is read 750 from the storage device and verified 760 as the digital data.

The implementation of the security features on the storage media device allows seamless integration with the imaging device. Only minor firmware updates would be envisaged and necessary on the imaging device. More importantly, the overall performance of the image device would not be affected by the securing of the data in accordance with the preferred embodiments of the invention. This additional security feature on a storage media card would provide trusted and reliable evidence for many law enforcement applications such as police investigations of a crime, accident insurance claims, digital content distribution and proof of ownership.

Since modifications within the spirit and scope of the invention may readily be effected by persons skilled within the art, it is to be understood that this invention is not limited to the particular embodiment described by way of example hereinabove.

For example, the same technique can be applied to other forms of media such as sound files. For example, the technique could be used to verify recordings made with a digital recording device.

In the claims which follow and in the preceding description of the invention, except where the context requires otherwise due to express language or necessary implication, the word “comprise”, or variations such as “comprises” or “comprising”, is used in an inclusive sense, i.e. to specify the presence of the stated features but not to preclude the presence or addition of further features in various embodiments of the invention.

1. A secure media storage device for an imaging device, comprising:
an interface for receiving digital data;
a memory for storing the digital data and for allowing read out of the digital data; and
a security layer integrated onto the storage device for embedding security data onto the digital data to enable verification of the integrity of the digital data.

2. A secure media storage device as claimed in claim 1, wherein the interface is adapted to receive digital data captured by an imaging device whereby the digital data can be read out of the memory to provide an image and the integrity of the image can be verified.

3. A secure media storage device as claimed in claim 1 or claim 2, wherein the security layer comprises a device for implementing a security algorithm.

4. A secure media storage device as claimed in claim 3, wherein the security algorithm is a digital watermarking algorithm.

5. A secure media storage device as claimed in any one of claims 1 to 4, wherein the security data is comprised of one or more of:
a media device identification;
a time stamp; and
a date stamp.

6. A security media storage device as claimed in any one of claims 3 to 5, wherein the security algorithm comprises a cryptographic algorithm.

7. A security media storage device as claimed in claim 6, wherein the cryptographic algorithm comprises a digital signature algorithm.

8. A security media storage device as claimed in any one of claims 1 to 7, wherein the security algorithm comprises a message digest algorithm.

9. A security media storage device as claimed in any one of claims 1 to 8, wherein the device for implementing the security algorithm comprises a security controller.

10. A security media storage device as claimed in claim 3, wherein the security algorithm comprises a digital signature algorithm, the digital signature algorithm comprising hashing part of the digital data to provide a fingerprint and employing private key encryption so that the entire signature forms part of a watermark bit stream watermarked onto the digital data.

11. A digital media device comprising a secure media storage device as claimed in any one of claims 1 to 10.

12. A digital media device as claimed in claim 11 comprising a digital imaging device.

13. A method of securing digital data, comprising:
receiving digital data onto a storage device;
storing the digital data on the storage device and allowing readout of the digital data; and
providing a security layer integrated onto the storage device to embed security data onto the digital data to enable verification of the integrity of the digital data.

14. A method as claimed in claim 13, comprising receiving data captured by a digital imagery device whereby an image produced from the digital data may be verified.

15. A method as claimed in claim 13 or claim 14, wherein the security layer comprises a security algorithm.

16. A method as claimed in claim 15, wherein the security algorithm is a digital watermarking algorithm.

17. A method as claimed in any one of claims 13 to 16, wherein the security data is comprised of one or more of:
a media device identification;
a time stamp; and
a date stamp.

18. A method as claimed in claim 15, wherein the security algorithm comprises a cryptographic algorithm.

19. A method as claimed in claim 15, wherein the security algorithm comprises a digital signature algorithm.

20. A method as claimed in claim 19, wherein the digital signature algorithm comprises hashing part of the digital data to provide a fingerprint and employs private key encryption so that the entire signature forms part of a watermark bit stream watermarked onto the digital data.
